(19) United States
(12) Patent Application Publication
(10) Pub. No.: US 2012/0147153 A1
(43) Pub. Date: Jun. 14, 2012

(54) DISPLAY APPARATUS AND METHOD FOR REAL-TIME RADIATION PATTERN VISUALIZATION

(75) Inventors: Hsing Chen LIN, Taichung City (TW); Kuo Shu Luo, Hsinchu City (TW); Li Dien Fu, Jinsha Township (TW)

(73) Assignee: INDUSTRIAL TECHNOLOGY RESEARCH INSTITUTE, Hsinchu (TW)

(21) Appl. No.: 13/052,644

(22) Filed: Mar. 21, 2011

(30) Foreign Application Priority Data
Dec. 14, 2010 (TW) 099143625

(51) Int. Cl. H04N 13/04; G01C 3/00

(52) U.S. Cl. 348/51; 356/3; 348/E13.075

(57) ABSTRACT

A display apparatus for real-time radiation pattern visualization comprises a positioning module, a radiation pattern measuring module and an image processing module. The positioning module is used to measure a distance of an object from the positioning module and locate the orientation of the object. The radiation pattern measuring module is used to receive radiation of the object. The image processing module is coupled with the positioning module and the radiation pattern measuring module, and processes the radiation to generate a stereoscopic radiation pattern signal. According to the distance and orientation of the object, the stereoscopic radiation pattern signal is displayed in the display interface for engineers in the workplace to estimate the calibration of the real-time radiation pattern.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The disclosure relates to a display apparatus. More particularly, the disclosure relates to a display apparatus for real-time radiation pattern visualization.

2. Description of Related Art

Including Information Disclosed Under 37 CFR 1.97 and 37 CFR 1.98.

Conference and exhibition service systems with radio-frequency identification (RFID) technology massively deploy RFID readers, which are easily disturbed by metal pieces and surrounding environment such that it is difficult to transmit or receive electromagnetic waves for exchanging data between the RFID readers and the RFID tags attached to bracelets. Thus, exhibition staff can utilize antennas and spectrum analyzers to plot the radiation pattern so as to monitor the distribution of antenna radiation patterns. However, although the exhibition staff or researchers can utilize antenna radiation pattern measuring systems, network analyzers, standard gain antennas, and other expensive instruments to measure radiation patterns of RFID devices in an anechoic chamber, the measuring process still includes many complicated and redundant steps. In addition, the measurement of antenna radiation pattern is easily disturbed by the location in which the antennas are disposed. Therefore, it is necessary to provide a display apparatus for real-time radiation pattern visualization in order to conveniently estimate the calibration of the current radiation pattern.

### BRIEF SUMMARY OF THE INVENTION

One aspect of the disclosure is to provide a display apparatus for real-time radiation pattern visualization. Since the disclosure simplifies many complicated measuring processes and ignores the measuring disturbance due to location effects, it can display the stereoscopic radiation pattern on the display apparatus by analyzing parameters of the radiation in realtime, allowing engineers to measure the real-time radiation pattern and to estimate the calibration of the current radiation pattern.

The display apparatus comprises a positioning module, a radiation pattern measuring module, and an image processing module. The positioning module measures a distance of an object from the positioning module and locates an orientation of the object. The radiation pattern measuring module receives a radiation of the object. The positioning module and the radiation pattern measuring module are coupled with the image processing module, which processes the radiation to generate a stereoscopic radiation pattern signal, which is displayed on a display interface.

The display method of one aspect of the disclosure comprises the following steps: measuring a distance of an object by a laser; locating an orientation of the object by a laser; receiving a radiation of the object and generating a stereoscopic radiation pattern signal; calibrating the stereoscopic radiation pattern signal according to the distance of the object; and displaying the calibrated stereoscopic radiation pattern signal.

### BRIEF DESCRIPTION OF THE SEVERAL VIEWS OF THE DRAWINGS

The accompanying drawings, which are incorporated in and constitute a part of this specification, illustrate embodiments of the disclosure and, together with the description, serve to explain the principles of the invention.

FIG. 1 is a perspective view illustrating a display apparatus according to one exemplary embodiment of the disclosure;

FIG. 2 is a perspective view illustrating a user wearing the display apparatus shown in FIG. 1 and observing the object according to one exemplary embodiment of the disclosure;

FIG. 3 is a block diagram illustrating a display apparatus according to one exemplary embodiment of the disclosure;

FIG. 4 is a rear panel illustrating a display apparatus according to another exemplary embodiment of the disclosure;

FIG. 5 is a perspective view illustrating a usage scenario of a display apparatus according to another exemplary embodiment of the disclosure;

FIG. 6 is a block diagram illustrating a display apparatus according to another exemplary embodiment of the disclosure;

FIG. 7 is a process flowchart illustrating a displaying method according to one exemplary embodiment of the disclosure; and

FIG. 8 is a process flowchart illustrating a displaying method according to another exemplary embodiment of the disclosure.

### DETAILED DESCRIPTION OF THE INVENTION

In the following description, numerous specific details are set forth. However, it is understood that embodiments of the invention may be practiced without these specific details. In other instances, well-known methods, structures and techniques have not been shown in detail in order not to obscure an understanding of this description.

References to “one embodiment,” “an embodiment,” “exemplary embodiment,” “another embodiments,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may. Unless specifically stated otherwise, as apparent from the following discussions, it is appreciated that throughout the specification discussions utilizing terms such as “processing,” “computing,” “measuring,” “locating,” “receiving,” “generating,” “recording,” “rectifying,” “displaying,” or the like, refer to the action and/or processes of a computer or computing system, or similar electronic computing device, state machine and the like that manipulate and/or transform data represented as physical, such as electronic, quantities into other data similarly represented as physical quantities.

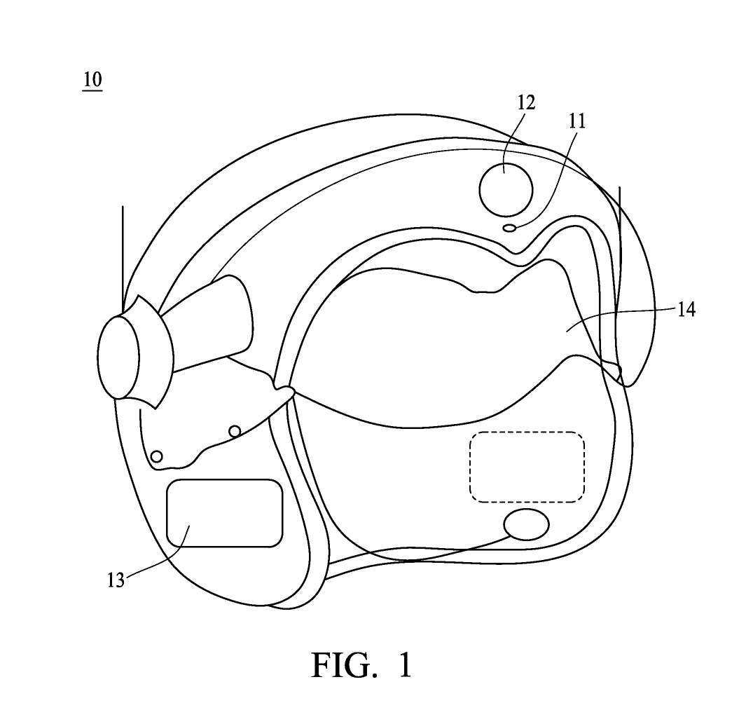

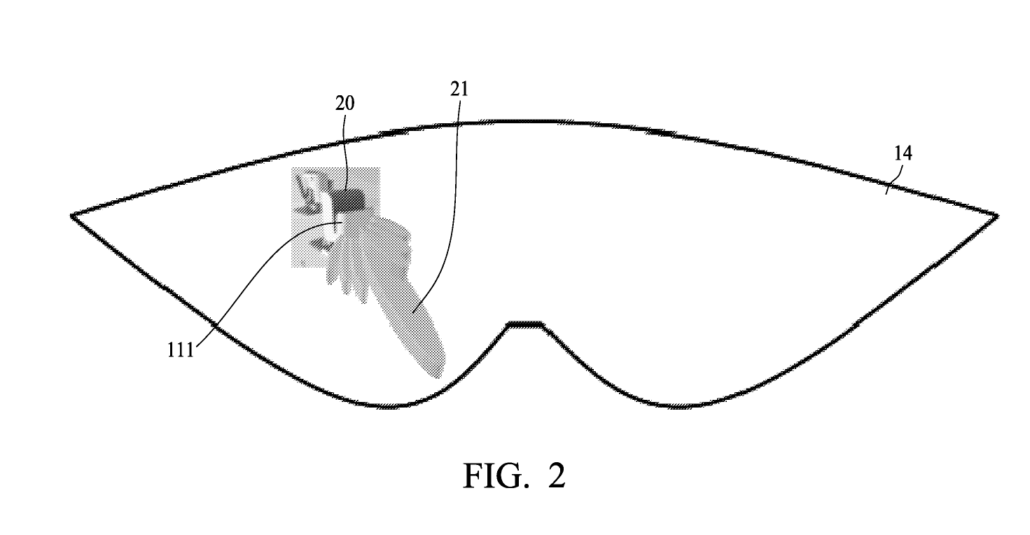

The display apparatus 10 for real-time radiation pattern visualization shown in FIG. 1 comprises a positioning module 11, a radiation pattern measuring module 12, and an image processing module 13. The user wearing the display apparatus 10 can observe an object 20 through a transparent lens 14, as shown in FIG. 2. The positioning module 11 can measure a distance of the object 20 and locate an orientation of the object 20. In the embodiment, the positioning module 11 preferably includes, but is not limited to, a laser range finder. Since the positioning module 11 locates the object 20 through the laser range finder, the object 20 is labeled with a laser spot 111, which enables the positioning module 11 to find the range between the object 20 and the positioning module 11.

Referring to the embodiment shown in FIG. 1 and FIG. 2, the object 20 might be an RFID reader, which transmits radiation or electromagnetic waves at a certain region. According to various designs or requirements, the RFID reader of this embodiment could be a portable RFID reader or a fixed RFID reader. In addition, the method of data exchange between the RFID reader and the RFID tag can be used by means of inductive load modulation or backward scattering in an electronic field. The RFID readers and tags can utilize different radio-frequency ranges, which are selected from the group consisting of low frequency (LF) of about 125 kHz, high frequency (HF) of about 13.56 MHz, ultra high frequency (UHF) from 850 to 950 MHz, and microwave from 2.40 to 2.48 GHz. For real-time radiation pattern visualization, the radiation pattern measuring module 12 of the disclosure is capable of receiving radiation transmitted from the object 20. Particularly, the radiation pattern measuring module 12 preferably includes, but is not limited to, an antenna. Since the antenna can be designed to receive different ranges of the radio frequency according to different requirements, the radiation pattern measuring module 12 is not limited to an unique antenna. Thus, the radiation pattern measuring module 12 can receive signals, which are not limited to the general radio-frequency ranges and can extend to other ranges for radiation pattern measurement. However, in the prior art, users cannot observe the radiation or radiation pattern of the object 20 in real time.

FIG. 1 shows that the image processing module 13 couples with the positioning module 11 and the radiation pattern measuring module 12. The image processing module 13 processes the radiation which is received by the radiation pattern measuring module 12 and then generates a stereoscopic radiation pattern signal. The stereoscopic radiation pattern signal combines with the distance and the orientation of the object 20 in measurement of the positioning module 11 and then is displayed on a display interface 14 such as the transparent lens 14 shown in FIGS. 1 and 2. Therefore, the real-time radiation pattern 21 visualization of the object 20 can be observed by the user through the transparent lens 14. In other words, visualization of the stereoscopic radiation pattern signal merges with the real object 20 in the transparent lens. In addition, since the radiation parameters transmitted from the object 20 can also be displayed in the transparent lens 14, the user can observe the radiation parameters and stereoscopic radiation pattern 21 of the object 20 in real time.

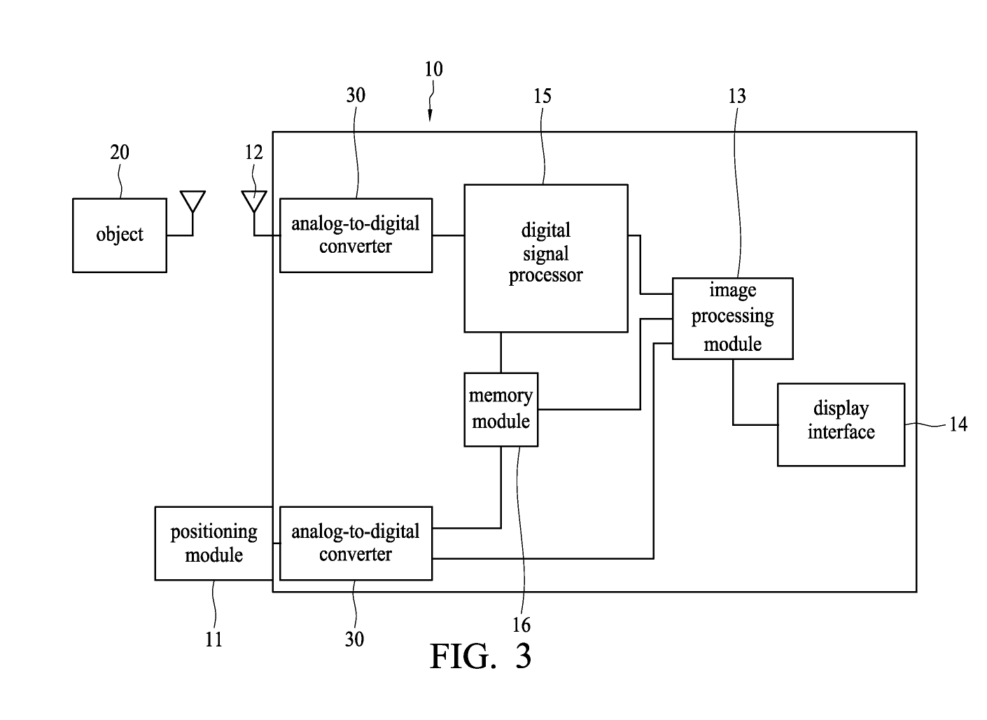

Referring to FIG. 3, the display apparatus 10 further includes a memory module 16 and a digital signal processor 15. For details of the scheme of the display apparatus 10, after the radiation pattern measuring module 12 receives radiation transmitted from the object 20, the analog signals received by the radiation pattern measuring module 12 are converted into digital signals by the analog-to-digital converter 30. Such digital signals are transmitted to the digital signal processor 15, which processes the measuring parameters of the radiation and eliminates fading process due to environmental multipath signal of the radiation. In other words, the digital signal processor 15 retrieves corresponding parameters of radiation such as radiation pattern, directivity, power gain, beamwidth, H-plane pattern, E-plane pattern and so on. In addition, the digital signal processor 15 also eliminates the fading process due to environmental multipath signal of the radiation. The radiation processed by the digital signal processor 15 is transmitted to the image processing module 13 or recorded into the memory module 16, which couples with the radiation pattern measuring module 12 and the positioning module 11. Moreover, the analog signals such as the distance of the object 20 measured and the orientation of object 20 located by the positioning module 11 through the analog-to-digital converter 30, are converted into digital signals for transmitting to the image processing module 13 or recording into the memory module 16. Therefore, the memory module 16 can record digital signals including the radiation, distances and the orientation of the object 20. Furthermore, the analog-to-digital converter 30 of the positioning module 11 and the digital signal processor 15 respectively transmit the distance and the orientation digital signals of the object 20 and radiation digital signal to the image processing module 13, which is capable of processing the above-mentioned digital signals to generate a stereoscopic radiation pattern signal and displaying the stereoscopic radiation pattern signal in the display interface 14 such as the transparent lens 14 shown in FIG. 2 so as to allow direct observation of the radiation 21 of the object 20. The display apparatus 10 can be applied to, but is not limited to, RFID readers and various devices transmitting radiation patterns such as laser system or other antennas.

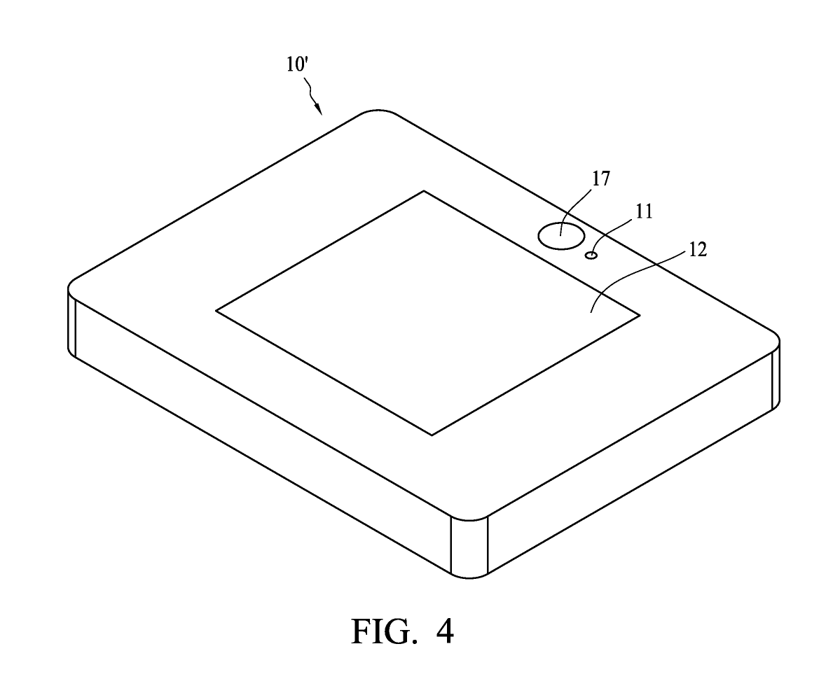

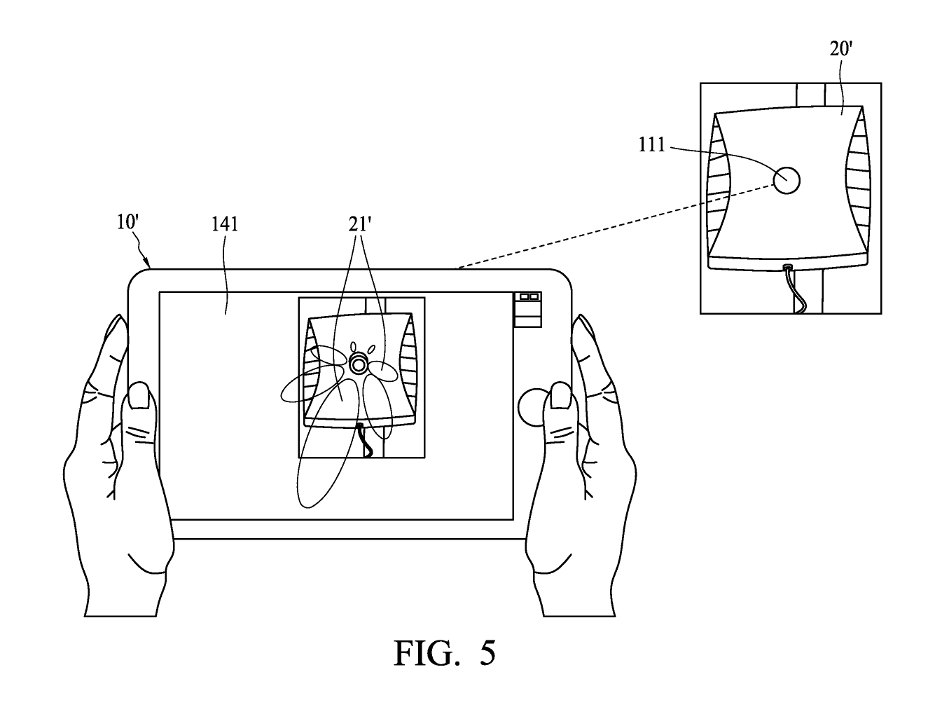

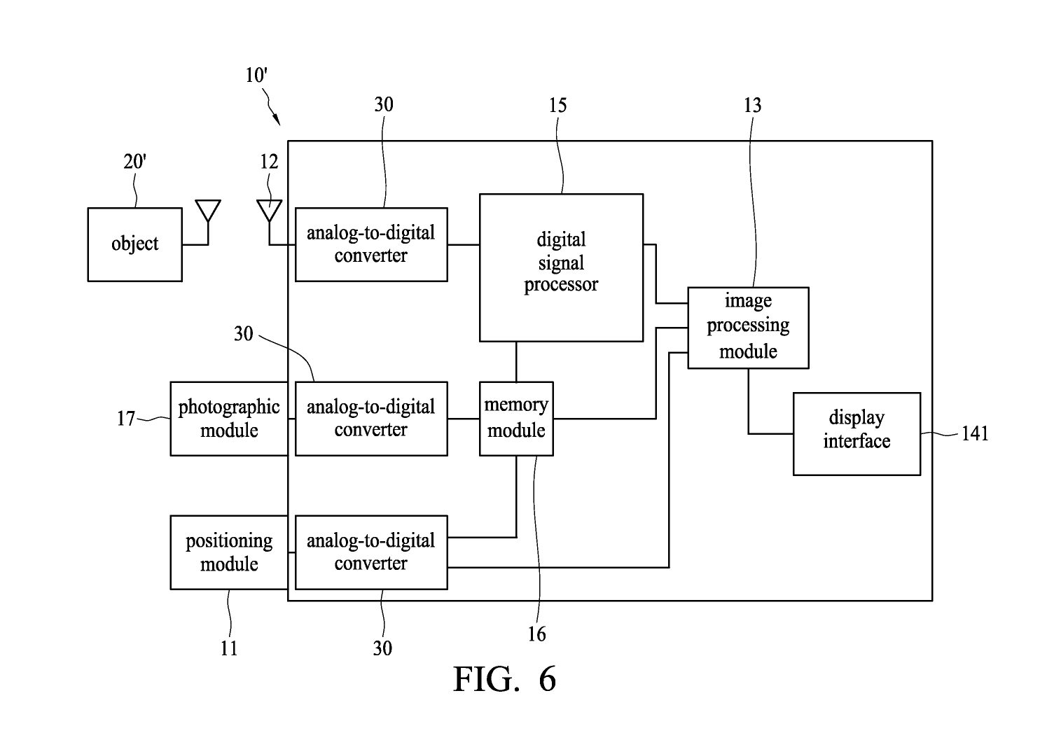

In another embodiment shown in FIGS. 4 to 6, FIG. 4 is a rear panel illustrating a handheld display apparatus 10′. The display apparatus 10′ for real-time radiation pattern visualization further includes a photographic module 17, which photographs the object 20′ and surrounding area to generate an image. The analog signal of the image is converted into a digital signal such as image data through the analog-to-digital converter 30. The image data can be recorded into the memory module 16. The image processing module 13 can access the image data in the memory module 16 and display the stereoscopic radiation pattern signal in the display interface 141, which is a display screen in the embodiment. Therefore, the user can observe the radiation 21′ transmitted from the object 20′ on the display screen 141 shown in FIG. 5. In addition, in the embodiment, the positioning module 11 preferably includes, but is not limited to, a laser range finder. Since the positioning module 11 locates the object 20′ through the laser range finder, the object 20′ is labeled with laser spot 111, which provides data including the distance and the orientation of the object 20′. When the above-mentioned data is combined with the image data from the photographic module 17, the image processing module 13 can process the orientation information of the image data and the distance and the orientation digital data to compute stereoscopic radiation pattern signals, including actual orientations and locations of the radiation pattern transmitted from the object 20′. After the display interface 141 displays the stereoscopic radiation pattern signals, the user can observe the actual radiation pattern 21′ transmitted from the object 20′ through the display interface 141.

Additionally, since the display apparatus for real-time radiation pattern visualization miniaturizes the huge antenna measuring instrument to be compacted in handheld device, in order to avoid the cost of establishing an anechoic chamber, and to skip redundant measuring steps. The disclosure provides several key techniques including (1) real-time radiation pattern visualization, (2) processing of the radiation pattern parameters, and (3) a method of eliminating the fading process due to environmental multipath signal of the radiation. The detail of these techniques is described in the following paragraphs.

The real-time radiation pattern visualization technique allows users to immediately observe the radiation pattern of the object by processing digital signals of the radiation pattern parameters through stereoscopic image processing.

Using the processing technique of the radiation pattern parameters to receive the Poynting vectors of the radiation field Eθ and Hφ, the display apparatus retrieves the radiation pattern parameters including radiation pattern, directivity, power gain, beamwidth, H-plane pattern, and E-plane pattern digital signals and then displays the stereoscopic signals including the above-mentioned radiation pattern parameters on the display interface.

The technique of eliminating the fading process due to environmental multipath signal of the radiation utilizes delay elimination and summation synthesis to obtain main signal while main signal is influenced on reflection, refraction, scattering, and diffraction.

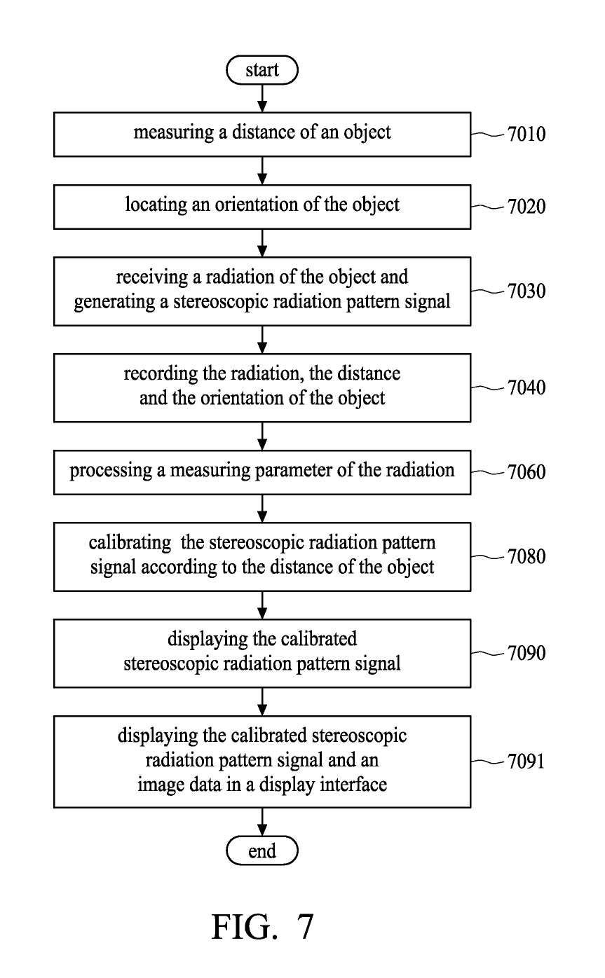

FIG. 7 shows a process flowchart of a display method for real-time radiation pattern visualization. In step 7010, a distance of an object is measured; in step 7020, an orientation of the object is located; in step 7030, a radiation of the object is received and a stereoscopic radiation pattern signal is generated; in step 7040, the radiation, distance, and orientation of the object are recorded; in step 7060, a measuring parameter of the radiation is processed; in step 7080, the stereoscopic radiation pattern signal is calibrated according to the distance of the object; in step 7090, the calibrated stereoscopic radiation pattern signal is displayed; and in step 7091, the calibrated stereoscopic radiation pattern signal and image data are displayed in a display interface.

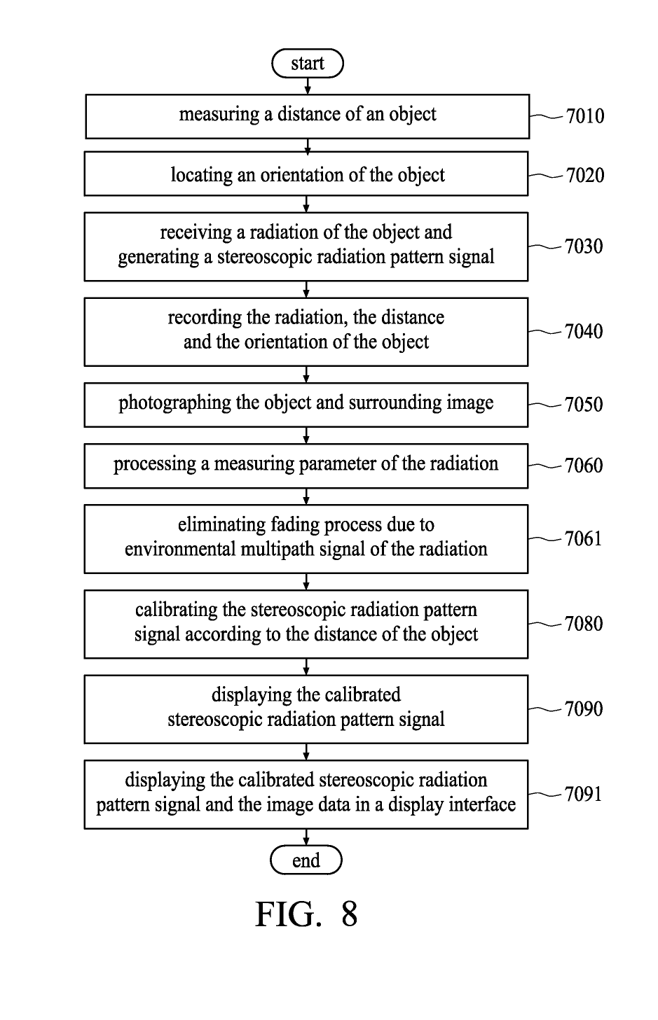

FIG. 8 shows another process flowchart of a display method for real-time radiation pattern visualization. In step 7010, a distance of an object is measured; in step 7020, an orientation of the object is located; in step 7030, a radiation of the object is received and a stereoscopic radiation pattern signal is generated; in step 7040, the radiation, distance, and orientation of the object are recorded; in step 7050, the object and surrounding image are photographed, and image data is generated and recorded; in step 7060, a measuring parameter of the radiation is processed; in step 7061, fading process due to environmental multipath signal of the radiation is eliminated; in step 7080, the stereoscopic radiation pattern signal is calibrated according to the distance of the object; in step 7090, the calibrated stereoscopic radiation pattern signal is displayed along with image data in a display interface in step 7091. The above-mentioned methods include several steps which can independently combine with individual steps to form a new displaying method.

Although the disclosure and its benefits have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the apparatus, process, machine, manufacturing, composition of matter, means, methods and steps described in the specification. As one of ordinary skill in the art will readily appreciate from the disclosure, apparatus, processes, machines, manufacturing, compositions of matter, means, methods, or steps, presently existing or later to be developed, that perform substantially the same function or achieve substantially the same result as the corresponding embodiments described herein may be utilized according to the disclosure. Accordingly, the appended claims are intended to include within their scope such apparatus, processes, machines, manufacturing, compositions of matter, means, methods, or steps.

We claim:

1. A display apparatus for real-time radiation pattern visualization, the display apparatus comprising:
a positioning module, which measures a distance of an object from the positioning module and locates an orientation of the object;
a radiation pattern measuring module, which receives a radiation of the object; and
an image processing module, which couples with the positioning module and the radiation pattern measuring module, wherein the image processing module processes the radiation to generate a stereoscopic radiation pattern signal, and the stereoscopic radiation pattern signal is displayed on a display interface according to the distance and orientation of the object.

2. The display apparatus of claim 1, further comprising a memory module, which is coupled with the radiation pattern measuring module and the positioning module, wherein the memory module records the radiation, the distance and the orientation of the object.

3. The display apparatus of claim 1, further comprising a photographic module, which photographs the object and surrounding image to generate image data, which is recorded in the memory module.

4. The display apparatus of claim 3, wherein the image processing module reads the image data and displays the stereoscopic radiation pattern signal and the image data in the display interface.

5. The display apparatus of claim 1, further including a digital signal processor, which processes a measuring parameter of the radiation and eliminates fading process due to environmental multipath signal of the radiation, wherein the digital signal processor transmits the processed radiation to the image processing module.

6. The display apparatus of claim 5, further including at least one analog-to-digital converter for converting a plurality of analog signals received by the positioning module, the radiation pattern measuring module, and the photographic module into a plurality of digital signals.

7. The display apparatus of claim 1, wherein the positioning module includes a laser range finder.

8. The display apparatus of claim 1, wherein the radiation pattern measuring module includes an antenna.

9. A displaying method for real-time radiation pattern visualization, the method comprising the following steps:
measuring a distance of an object;
locating an orientation of the object;
receiving a radiation of the object and generating a stereoscopic radiation pattern signal;
recording the radiation, the distance and the orientation of the object;
processing a measuring parameter of the radiation;
calibrating the stereoscopic radiation pattern signal according to the distance of the object;
displaying the calibrated stereoscopic radiation pattern signal; and
displaying the calibrated stereoscopic radiation pattern signal and image data in a display interface.

10. The displaying method of claim 9, further comprising the step of photographing the object and surrounding image to generate image data and to record the image data.

11. The displaying method of claim 10, wherein the parameter processing step further includes the step of eliminating fading process due to environmental multipath signal of the radiation.
